(19) United States
(12) Patent Application Publication
(10) Pub. No.: US 2011/0153503 A1
(43) Pub. Date: Jun. 23, 2011

(54) Device and Method for Identity Theft Resistant Transcations

(76) Inventors: Charles Blewett, Madison, NJ (US); Megan Blewett, Cambridge, MA (US); Juan Garay, Guttenburg, NJ (US); Robert Haarde, Sudbury, MA (US); Thomas Killian, Westfield, NJ (US); Simon Urbanek, Madison, NJ (US)

(21) Appl. No.: 12/646,419

(22) Filed: Dec. 23, 2009

(51) Int. Cl. H04L 9/32; G06Q 20/00; G06Q 30/00

(52) U.S. Cl. 705/67

(57) ABSTRACT

An authorization device includes an input module, a key generator, and an output module. The input module receives a request to authorize a transaction between a mobile device and a merchant terminal. The key generator generates a key used for authorizing the transaction. The key relates only to the transaction. The output module transmits an authorization for the transaction that is based on a processing of the key.

### BACKGROUND

A financial transaction occurs when a first party requests merchandise from a second party in exchange for monetary compensation. The exchange of monetary compensation may include a variety of different types such as cash, credit card, debit card, etc. When using credit or debit cards, a third party is involved to provide the monetary compensation on behalf of the first party or draw funds of the first party from a remote source, respectively. However, using credit or debit cards includes an inherent identity theft factor in which unauthorized parties use the credit or debit card.

Another exchange of monetary compensation may include a use of a wireless device. The wireless device may transmit data to a merchant terminal to authorize a transaction. However, the use of the wireless device also inherently includes an identity theft factor as the data transmitted relates to privileged information such as a wireless device user's credit card number, a telephone number, etc. Furthermore, other identity theft issues arise such as when the wireless device is stolen.

### SUMMARY OF THE INVENTION

The exemplary embodiments describe an authorization device. The authorization device comprises an input module, a key generator, and an output module. The input module receives a request to authorize a transaction between a mobile device and a merchant terminal. The key generator generates a key used for authorizing the transaction. The key relates only to the transaction. The output module transmits an authorization for the transaction that is based on a processing of the key.

### DESCRIPTION OF THE DRAWINGS

FIG. 1 shows a network according to an exemplary embodiment.

FIG. 2 shows a server for the network of FIG. 1 according to an exemplary embodiment.

FIG. 3 shows a method for executing identity theft resistant transactions according to an exemplary embodiment.

### DETAILED DESCRIPTION

The exemplary embodiments may be further understood with reference to the following description and the appended drawings, wherein like elements are referred to with the same reference numerals. The exemplary embodiments describe a device and method for executing a transaction that is resistant to theft identity. Specifically, the system may utilize transaction keys that are independent to a user of a wireless device who is remitting a payment. The transaction, the theft identity resistance, the transaction keys, the wireless device, and a related method will be discussed in further detail below.

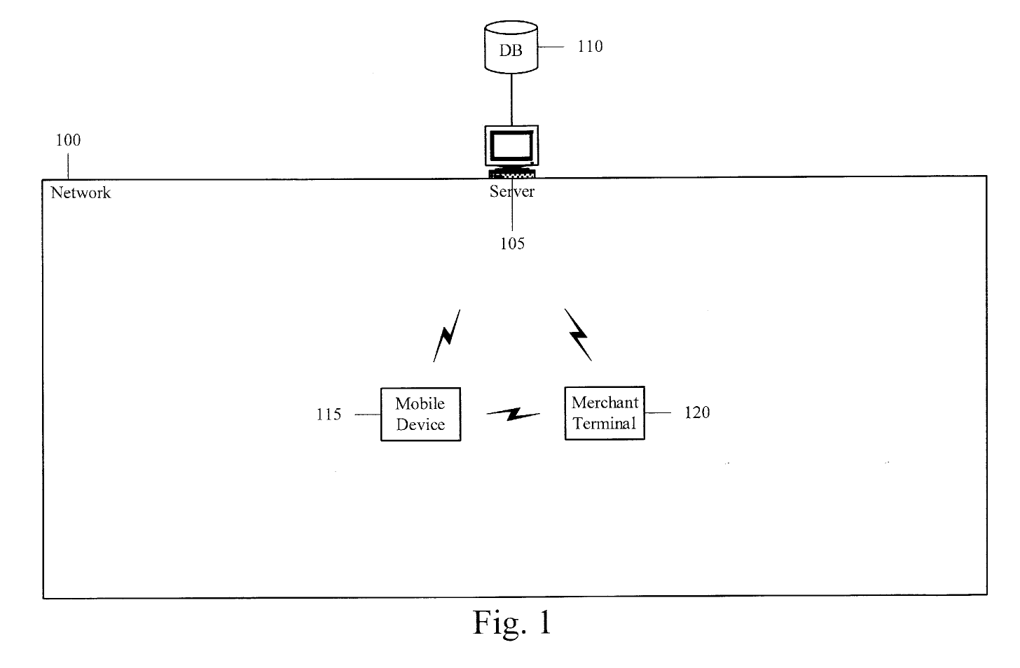

FIG. 1 shows a network 100 according to an exemplary embodiment. The network 100 may enable mobile devices to connect thereto so that mobile services may be provided. The network 100 may include a variety of different types of networks such as Global System for Mobile Communications (GSM), Near Field Communication (NFC), 2G, 3G, and long term evolution (LTE). Accordingly, respective of the type of network, mobile services may be provided to the mobile devices. As will be discussed in further detail below, the exemplary embodiments provide a means to resist identity theft when a mobile device is used to perform a transaction. The network 100 may include a server 105 and a database 110 that, together with a mobile device 115 and a merchant terminal 120, form the network 100.

It should be noted that the network 100 may include further components. For example, the network 100 may include cell stations, access points, etc. The cell stations may provide a coverage area in which a type of network (e.g., 2G, 3G, LTE) is provided. The cell stations and/or access points may also increase an overall coverage for the network 100. Thus, the mobile device 115 may be disposed within a coverage area of a cell station which relays signals to the server 105.

The server 105 and the database 110 may provide conventional functionalities for the overall network 100. As will be described in further detail below, the server 105 may also be configured to perform ad hoc verifications to authorize a transaction.

The mobile device 115 may be any portable electronic device capable of transmitting signals. According to the exemplary embodiments, the mobile device 115 may be configured to transmit signals to the server 105 and to the merchant terminal 120. For example, the mobile device 115 may include a long range transceiver using conventional transmission methods. In another example, the mobile device 115 may also include a short range transceiver using conventional transmission methods. In yet another example, the mobile device 115 may include a combined transceiver to perform the long range and the short range transmissions. The mobile device 115 may have software installed thereon which is used to perform the transaction according to the exemplary embodiments. It should be noted that the description of the exemplary embodiments does not require the mobile device 115 to have additional hardware components. However, in another exemplary embodiment, the mobile device 115 may have a hardware component installed therein or a module connected thereto to perform the transaction.

The merchant terminal 120 may also be configured in a substantially similar manner as the mobile device 115. That is, the merchant terminal 120 may also be configured for short range and long range transmissions. However, because the merchant terminal 120 may be a stationary computing device, the merchant terminal 120 may include a wired connection for transmission of signals to the server 105. The merchant terminal 120 may also have software installed thereon to perform the transaction according to the exemplary embodiments. However, like the mobile device 115, the merchant terminal 120 may also include further hardware components and/or modules to perform the transaction.

It should be noted that the short range communications for the mobile device 115 and/or the merchant terminal 120 is only exemplary. As will be described in further detail below, the resistance of identity theft according to the exemplary embodiments may be performed without the use of the short range transmissions. In particular, a manual input may be used in place of the short range transmissions.

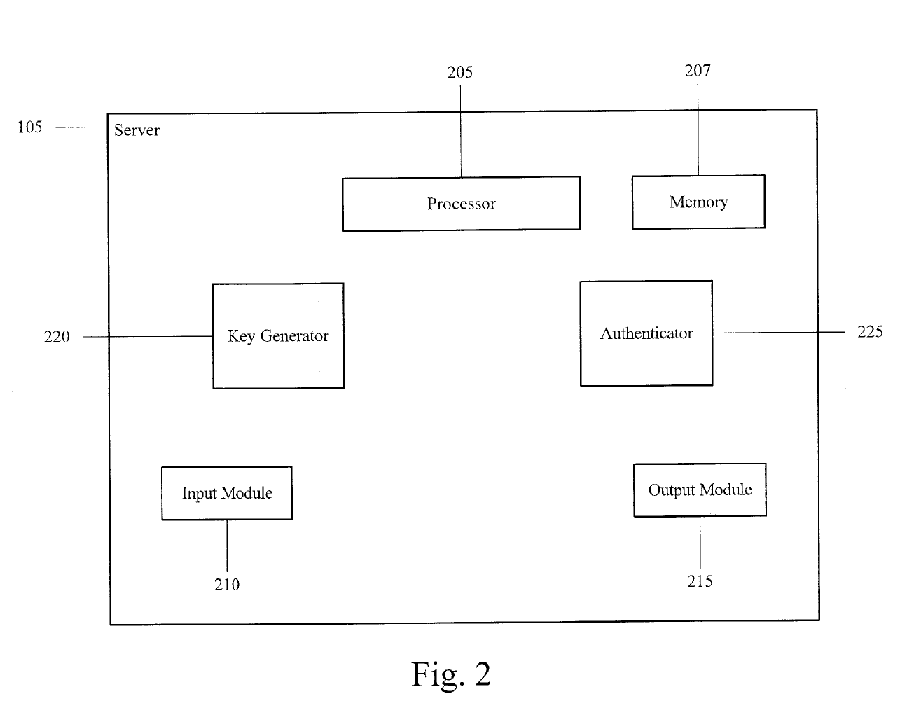

FIG. 2 shows the server 105 for the network 100 of FIG. 1 according to an exemplary embodiment. The server 105 may include a processor 205, a memory 207, an input module 210, an output module 215, a key generator 220, and an authenticator 225. The processor 205 may execute processes related to the conventional functionalities that the server 105 provides for the network 100. The memory 207 may store data related to the functionalities of the processor 205. The input module 210 may receive signals such as those transmitted from the mobile device 115 and/or the merchant terminal 120. The output module 215 may transmit signals such as to the mobile device 115 and/or the merchant terminal 120.

The key generator 220 may be used to produce a short-lived key that is related to a particular transaction. The short-lived key may be related to the transaction, thereby being independent from the mobile device 115. The key may be a variety of different types. In a first example, the key may be associated with a barcode (e.g., two-dimensional, three-dimensional, color, etc.). In a second example, the key may be associated with a string of numbers/letters. Thus, the barcode or alphanumeric string may be used to represent and/or transmit the key. For example, the key may be amenable for transmission into a graphical representation and display on the user device. According to the exemplary embodiments, the short-lived key may be a binary (or equivalently represented) string such that it provides a security measure. For example, the short-lived key may be long enough to be infeasible to guess.

The authenticator 225 may be configured for various types of authentications, authorizations, and/or verifications. In a first example, the authenticator 225 may be configured to authenticate the mobile device 115. The database 110 may store data of the mobile devices disposed in the network 100. The authenticator 225 may receive authentication data from the mobile device 115 and reference the data in the database 110 to authenticate the mobile device 115 that is requesting a transaction. In a second example, the authenticator 225 may authorize the transaction. As will be discussed below, the authenticator 225 may receive the key from the merchant terminal 120 for the authorization. In a third example, the authenticator 225 may verify the transaction. Specifically, upon authorizing the transaction, the authenticator 225 may prompt the mobile device 115 to verify that the transaction is correct.

According to the exemplary embodiments, the mobile device 115 may be located in a nearby vicinity of the merchant terminal 120. Specifically, the merchant terminal 120 may be disposed in a retail facility in which items may be purchased. The mobile device 115 may then be used for the transaction to purchase the items. The mobile device 115 may initially contact the server 105 to request the transaction. Upon receiving the request, the server 105 may authenticate the mobile device 115 to ensure that the mobile device 115 is an authorized device or the current user of the mobile device is an authorized user for the mobile device 115. As discussed above, the authenticator 225 may transmit a prompt to the mobile device 115 via the output module 215. The user of the mobile device 115 may enter data requested by the prompt. The data may be received by the authenticator 225 via the input module 210.

Once authenticated, the key generator 220 may produce a short-lived key to be used for this particular transaction. The short-lived key may exist for the duration of the transaction or a predetermined time-out length. For example, the duration of the transaction may last until the transaction is completed. In another example, the duration of the transaction may last until the transaction is aborted. In yet another example, the key may be programmed with a time-out period (e.g., 5 minutes) so that when the time-out period lapses, the key is no longer valid.

As discussed above, the key may be a variety of types. The key may be transmitted via the output module 215 to the mobile device 115. The key may be shown on a display of the mobile device 115. The merchant terminal 120 may request the key in a variety of ways depending on the type of key being used. In a first example, when the key is represented as a barcode, the mobile device 115 may show the barcode on a display thereof. Subsequently, the merchant terminal 120 may include a scanner which reads the barcode to receive the key. In a second example, when the key is represented as a sequence of letters/numbers, the merchant terminal 120 may include a keypad in which a user of the mobile device 115 and/or the merchant terminal may manually enter the sequence. In a third example, the mobile device 115 may wirelessly transmit the key to the merchant terminal 120 such as using a short range transmission (e.g., Bluetooth, Zigbee, infrared, etc.). It should be noted that the key may also relate to a multi-tier authentication data. That is, the key may relate to authentication data related to a user name, user account, and/or associated password. The key may also relate to other authentication data such as an IMEI identification, a MSISDN identification, other GSM SIM card identification, etc.

Once the merchant terminal 120 receives the key, the merchant terminal 120 may transmit the key and details of the transaction to the authenticator 225. It should be noted that the merchant terminal 120 may already be connected to the server 105 prior to transmitting the key. The server 105 may track the short-lived key for the transaction so that if an identical key is returned from the merchant terminal 120, the authenticator 225 may easily authorize the transaction. The short-lived key may be stored, for example, in the memory 207. Because the key is short-lived, the storing in the memory 207 may be temporary until the transaction is aborted or completed. It should be noted that when the authenticator 225 receives the key from the merchant terminal 120, the authenticator 225 may also correlate the key to the mobile device 115. Those skilled in the art will understand that as this stage may be the sole correlation to the mobile device 115, the identity theft resistance feature of the exemplary embodiments may be enhanced.

The authenticator 225 may subsequently verify the transaction by prompting the mobile device 115 once again. The prompt may request that the transaction details are correct. For example, the prompt may list the items to be purchased with a total amount. If the user of the mobile device 115 sees a discrepancy, the prompt may return a negative response. If the authenticator receives a verification from the mobile device 115, an authorization for the transaction may be transmitted to the merchant terminal 120 to finalize the transaction.

It should be noted that according to the exemplary embodiments, a hypertext transfer protocol secure (HTTPS) means may be used to avoid unauthorized access of transmissions. That is, the HTTPS may further enhance the identity theft resistance feature. Specifically, a first “hidden” key may be used for the mobile device 115 and a second hidden key may be used for the merchant terminal. These hidden keys may be used for communications between the server 105 and other parties.

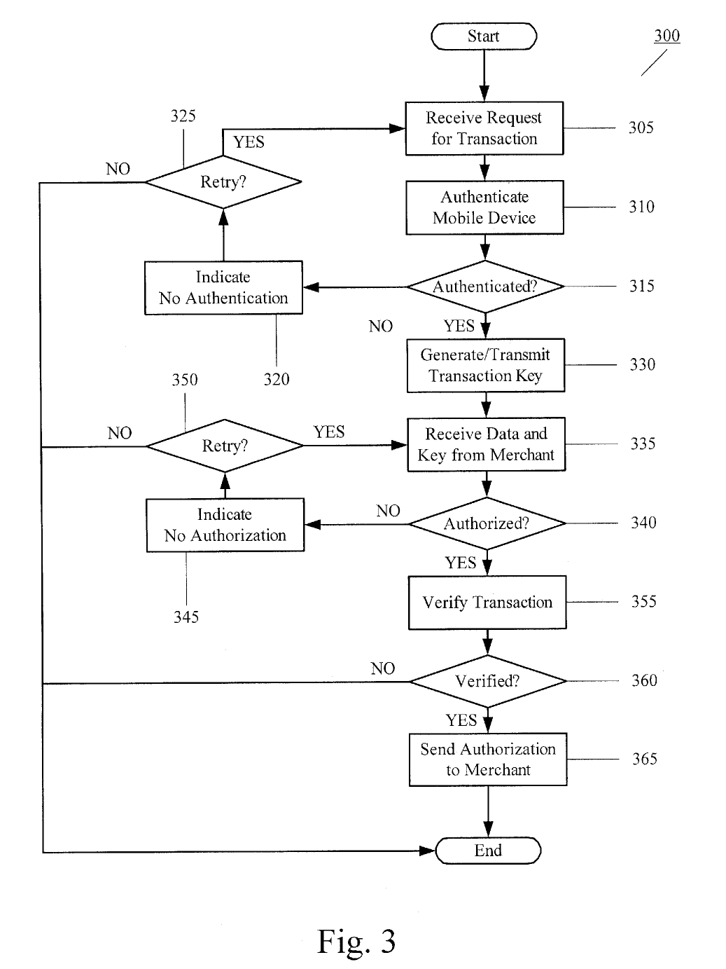

FIG. 3 shows a method 300 for authorizing a transaction that is resistant to identity theft using a mobile device. As described above and in further detail below, the method 300 may include a use of an independent, short-lived key to be used for a specific transaction. The method 300 may also include a plurality of authentication steps to further resist identity theft. The method 300 will be described with reference to the network 100 of FIG. 1 and the server 105 of FIG. 2. The method 300 will be described with reference to the server 105.

In step 305, the server 105 receives a request for a transaction via the input module 210. The request may be transmitted from the mobile device 115. As discussed above, the request may be for the transaction in which items are to be purchased. In step 310, the authenticator 225 authenticates the mobile device 115. The authentication may be performed by initially prompting the mobile device 115 to provide data used for the authentication. For example, the prompt may be for a login and password for the user of the mobile device 115.

In step 315, a determination is made by the authenticator 225 whether the mobile device 115 or the user of the mobile device 115 is authenticated based upon the response from the prompt. It should be noted that the authenticator 225 may receive the request with authenticating data concurrently without a need for a further prompt upon receiving the request.

If the mobile device 115 is not authenticated, the method 300 continues to step 320 where the authenticator 225 indicates that the authentication failed. For example, the authenticator 225 may transmit via the output module 215 a message to indicate the failure result. In step 325, a determination is made whether the authentication is to be retried. For example, when the message is transmitted by the authenticator 225, a follow-up prompt may be issued in which the authentication is to be attempted again. If no further attempts to authenticate the mobile device 115 is requested, then the method 300 ends. If a further attempt is requested, then the method 300 returns to step 305.

If the mobile device 115 is authenticated, the method 300 continues to step 330. In step 330, the key generator 220 generates the short-lived key for the transaction being requested. As discussed above, the short-lived key may be in a variety of forms. In step 330, the key is also transmitted via the output module 215 to the mobile device 115.

As stated above, the method 300 is described herein with respect to the server 105. Additional steps after step 330 may relate to the mobile device 115 and the merchant terminal 120. For example, once the mobile device 115 receives the key, the merchant terminal may receive the key from the mobile device 115. The key may be received using a variety of methods (e.g., via scan, via manual entry, via transmission, etc.). Upon receiving the key at the merchant terminal 120, the merchant terminal 120 may transmit details of the transaction and the key to the server 105 for authorization.

In step 335, the authenticator 225 receives the key. In step 340, a determination is made whether the transaction is to be authorized. Specifically, the authenticator 225 references the short-lived key for the transaction that may be stored on the memory 207 with the key received from the merchant terminal 120. If the determination indicates that the authorization failed, the method 300 continues to 345 where a message is transmitted from the authenticator 225 to the merchant terminal 120. Subsequently, a prompt may be issued in step 350 to retry the authorization in which the key may be exchange between the mobile device 115 and the merchant terminal 120. If no retry is requested, the method 300 ends. If a retry is requested, the method 300 returns to step 335.

If the key transmitted by the merchant terminal 120 is authorized, the method 300 continues to step 355. In step 355, the authenticator 225 verifies the transaction by transmitting a further prompt to the mobile device 115. Specifically, the prompt may include details of the transaction (e.g., items to be purchased, a total amount of the purchase, etc.). A request may be made via the prompt for the user of the mobile device 115 to indicate that the transaction is to continue or for the user to indicate that the details of the transaction are correct. If the reply to the prompt indicates that the transaction details are incorrect and thus not verified, the method 300 ends. If the reply to the prompt indicates that the transaction details are correct and thus verified, the method 300 continues to step 365 where the authenticator 225 transmits authorization to the merchant terminal 120 which completes the transaction.

The exemplary embodiments provide for a device that enables a transaction between a mobile device and a merchant terminal using a short-lived key that is particular to the transaction. The use of the short-lived key with various verification steps enables a identity theft resistant means of authorizing the transaction. An initial authentication of the mobile device may be performed as part of the verification steps. A subsequent authorization of the transaction may be performed as a second part of the verification steps in which the key is passed from the mobile device to the merchant terminal. A final verification of the transaction may be performed as a third part of the verification steps in which the mobile device indicates that the transaction is correct and wishes to continue with completing the transaction.

Those skilled in the art will understand that the above described exemplary embodiments may be implemented in any number of manners, including, as a separate software module, as a combination of hardware and software, etc. For example, the key generator 220 and the authenticator 225 may be a program containing lines of code that, when compiled, may be executed on the processor 205.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. An authorization device, comprising:
an input module receiving a request to authorize a transaction between a mobile device and a merchant terminal;
a key generator generating a key used for authorizing the transaction, the key relating only to the transaction; and
an output module transmitting an authorization for the transaction based on a processing of the key.

2. The authorization device of claim 1, wherein the key is short-lived.

3. The authorization device of claim 1, wherein the key is one of a barcode and an alphanumeric string.

4. The authorization device of claim 1, further comprising:
an authenticator authenticating the mobile device.

5. The authorization device of claim 4, wherein the authenticator further authorizes the transaction when the key received by the mobile device is received by the authorization device from the merchant terminal.

6. The authorization device of claim 4, wherein the authenticator further verifies the transaction by requesting a reply from the mobile device as to whether details of the transaction are correct.

7. The authorization device of claim 1, wherein the mobile device and the merchant terminal are in a close proximity to enable short-range communications therebetween.

8. The authorization device of claim 7, wherein the key is transmitted from the mobile device to the merchant terminal using one of a wireless transmission, a manual entry, and a scan.

9. The authorization device of claim 1, further comprising:
a memory temporarily storing the key.

10. The authorization device of claim 4, wherein the authenticator accesses a database storing authentication data related to the mobile device.

11. A method, comprising:
receiving a request to authorize a transaction between a mobile device and a merchant terminal;
generating a key used for authorizing the transaction, the key relating only to the transaction; and
transmitting an authorization for the transaction that is based on a processing of the key.

12. The method of claim 11, wherein the key is short-lived.

13. The method of claim 11, wherein the key is one of a barcode and an alphanumeric string.

14. The method of claim 11, further comprising:
authenticating the mobile device.

15. The method of claim 11, further comprising:
authorizing the transaction when the key received by the mobile device is transmitted by the merchant terminal.

16. The method of claim 11, further comprising:
verifying the transaction by requesting a reply from the mobile device as to whether details of the transaction are correct.

17. The method of claim 11, wherein the mobile device and the merchant terminal are in a close proximity to enable short range communications therebetween.

18. The method of claim 17, wherein the key is transmitted from the mobile device to the merchant terminal using one of a wireless transmission, a manual entry, and a scan.

19. The method of claim 11, further comprising:
temporarily storing the key.

20. An authorization device, comprising:
a receiving means for receiving a request to authorize a transaction between a mobile device and a merchant terminal;
a generating means for generating a key used for authorizing the transaction, the key relating only to the transaction; and
a transmitting means for transmitting an authorization for the transaction based on a processing of the key.
